(19) United States
(12) Patent Application Publication
(10) Pub. No.: US 2025/0097962 A1
(43) Pub. Date: Mar. 20, 2025

(54) METHOD AND APPARATUS FOR MANAGING DRX ACTIVE TIME FOR MULTICAST RECEPTION IN RRC INACTIVE STATE IN WIRELESS COMMUNICATION SYSTEM

(71) Applicant: SAMSUNG ELECTRONICS CO., LTD., Suwon-si (KR)

(72) Inventors: Sangkyu BAEK, Suwon-si (KR); Anil AGIWAL, Mountain View, CA (US)

(21) Appl. No.: 18/888,059

(22) Filed: Sep. 17, 2024

Related U.S. Application Data
(60) Provisional application No. 63/583,810, filed on Sep. 19, 2023.

(51) Int. Cl. H04W 72/30; H04L 1/1812; H04W 76/27

(52) U.S. Cl. CPC H04W 72/30; H04L 1/1812; H04W 76/27

(57) ABSTRACT

The disclosure relates to a 5G or 6G communication system for supporting a higher data transmission rate. Specifically, the disclosure provides a method and an apparatus for managing a discontinuous reception (DRX) active time such that multicast and broadcast service (MBS) reception is performed efficiently in an radio resource control (RRC) inactive state.

### CROSS-REFERENCE TO RELATED APPLICATION

This application is based on and claims priority under 35 U.S.C. § 119 to U.S. Provisional Patent Application No. 63/583,810, filed on Sep. 19, 2023, in the USPTO, the disclosure of which is herein incorporated by reference in its entirety.

### BACKGROUND

### 1. Field

The disclosure relates to a wireless communication system (or mobile communication system). More particularly, the disclosure relates to a method and an apparatus for managing a discontinuous reception (DRX) active time for multicast reception by a UE in a radio resource control (RRC) inactive state in a wireless communication system (or mobile communication system).

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mm Wave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mm Wave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

In line with development of communication systems, there have been increasing demands for various methods for efficiently performing multicast transmission and reception.

### SUMMARY

The disclosure may provide a method and an apparatus for managing a discontinuous reception (DRX) active time such that a UE in an RRC inactive state effectively performs multicast reception in a wireless communication system (or mobile communication system).

According to an embodiment of the disclosure, a method performed by a terminal is provided. The method comprises: receiving, from a base station, a radio resource control (RRC) release message including a suspend configuration, wherein the suspend configuration includes a multicast and broadcast service (MBS) multicast configuration for an RRC inactive state; receiving, from the base station while the terminal is in the RRC inactive state, a multicast transmission for a group radio network temporary identity (G-RNTI) based on the MBS multicast configuration; and in case that a discontinuous reception hybrid automatic repeat request round trip time timer for downlink point to multipoint (drx-HARQ-RTT-TimerDL-PTM) is included in the MBS multicast configuration for the RRC inactive state, starting the drx-HARQ-RTT-TimerDL-PTM after an end of the multicast transmission.

According to an embodiment of the disclosure, a method performed by a base station is provided. The method comprises: transmitting, to a terminal, a radio resource control (RRC) release message including a suspend configuration, wherein the suspend configuration includes a multicast and broadcast service (MBS) multicast configuration for an RRC inactive state; and transmitting, to the terminal in the RRC inactive state, a multicast transmission for a group radio network temporary identity (G-RNTI) based on the MBS multicast configuration, wherein a discontinuous reception hybrid automatic repeat request round trip time timer for downlink point to multipoint (drx-HARQ-RTT-TimerDL-PTM) included in the MBS multicast configuration is started after an end of the multicast transmission.

According to an embodiment of the disclosure, a terminal is provided. The terminal comprises: a transceiver; and a controller coupled with the transceiver and configured to: receive, from a base station, a radio resource control (RRC) release message including a suspend configuration, wherein the suspend configuration includes a multicast and broadcast service (MBS) multicast configuration for an RRC inactive state, receive, from the base station while the terminal is in the RRC inactive state, a multicast transmission for a group radio network temporary identity (G-RNTI) based on the MBS multicast configuration, and in case that a discontinuous reception hybrid automatic repeat request round trip time timer for downlink point to multipoint (drx-HARQ-RTT-TimerDL-PTM) is included in the MBS multicast configuration for the RRC inactive state, start the drx-HARQ-RTT-TimerDL-PTM after an end of the multicast transmission.

According to an embodiment of the disclosure, a base station is provided. The base station comprises: a transceiver; and a controller coupled with the transceiver and configured to: transmit, to a terminal, a radio resource control (RRC) release message including a suspend configuration, wherein the suspend configuration includes a multicast and broadcast service (MBS) multicast configuration for an RRC inactive state, and transmit, to the terminal in the RRC inactive state, a multicast transmission for a group radio network temporary identity (G-RNTI) based on the MBS multicast configuration, wherein a discontinuous reception hybrid automatic repeat request round trip time timer for downlink point to multipoint (drx-HARQ-RTT-TimerDL-PTM) included in the MBS multicast configuration is started after an end of the multicast transmission.

Various embodiments proposed in the disclosure are advantageous in that a UE and a gNB manage a DRX active time such that multicast reception regarding a UE in an RRC inactive state is performed effectively.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates the operating scheme of multicast and broadcast service (MBS) communication according to an embodiment of the disclosure;

FIG. 2 illustrates a multicast DRX operation of a UE in an RRC_connected mode according to an embodiment of the disclosure;

FIG. 3 illustrates a multicast DRX operation of a UE in an RRC inactive mode according to another embodiment of the disclosure;

FIG. 4 illustrates a multicast DRX operation of a UE in an RRC inactive mode according to another embodiment of the disclosure;

FIG. 5 illustrates a multicast DRX operation of a UE in an RRC inactive mode according to another embodiment of the disclosure;

FIG. 6 illustrates a multicast DRX operation of a UE in an RRC inactive mode according to another embodiment of the disclosure;

FIG. 7 illustrates a multicast DRX operation of a UE in an RRC inactive mode according to another embodiment of the disclosure;

FIG. 8 illustrates a multicast DRX operation of a UE in an RRC inactive mode according to another embodiment of the disclosure; and

FIG. 9 illustrates a multicast DRX operation of a UE in an RRC inactive mode according to another embodiment of the disclosure.

FIG. 10 illustrates a structure of a base station according to an embodiment of the disclosure; and

FIG. 11 illustrates a structure of a UE according to an embodiment of the disclosure.

### DETAILED DESCRIPTION

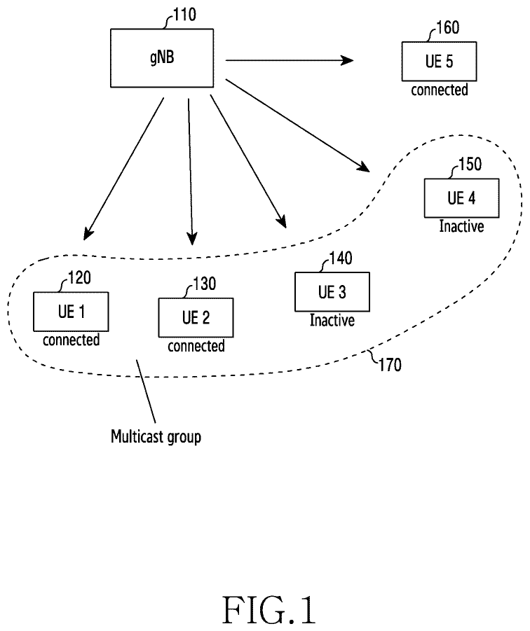

FIGS. 1 through 11, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, embodiments of the disclosure will be described in detail with reference to the accompanying drawings.

In describing the disclosure below, a detailed description of known functions or configurations incorporated herein will be omitted when it is determined that the description may make the subject matter of the disclosure unnecessarily unclear. Hereinafter, embodiments of the disclosure will be described with reference to the accompanying drawings.

For the same reason, in the accompanying drawings, some elements may be exaggerated, omitted, or schematically illustrated. Furthermore, the size of each element does not completely reflect the actual size. In the respective drawings, identical or corresponding elements are provided with identical reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements. Furthermore, in describing the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

The following detailed description of embodiments of the disclosure is mainly directed to New RAN (NR) as a radio access network and Packet Core (5G system or 5G core network or next generation core (NG Core)) as a core network in the 5G mobile communication standards specified by the 3rd generation partnership project (3GPP) that is a mobile communication standardization group, but based on determinations by those skilled in the art, the main idea of the disclosure may be applied to other communication systems having similar backgrounds through some modifications without significantly departing from the scope of the disclosure.

In the following description, some of terms and names defined in the 3GPP standards (standards for 5G, NR, LTE, or similar systems) may be used for the sake of descriptive convenience. However, the disclosure is not limited by these terms and names, and may be applied in the same way to systems that conform other standards.

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as used herein, and other terms referring to subjects having equivalent technical meanings may be used.

In the following description, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing a communication function. In the disclosure, a “downlink (DL)” refers to a radio link via which a base station transmits a signal to a terminal, and an “uplink (UL)” refers to a radio link via which a terminal transmits a signal to a base station.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the “unit” refers to a software element or a hardware element, such as a field programmable gate array (FPGA) or an application specific integrated circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more CPUs within a device or a security multimedia card. Furthermore, the “unit” in embodiments may include one or more processors.

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as described below, and other terms referring to subjects having equivalent technical meanings may also be used.

In the following description, the terms “physical channel” and “signal” may be interchangeably used with the term “data” or “control signal”. For example, the term “physical downlink shared channel (PDSCH)” refers to a physical channel over which data is transmitted, but the PDSCH may also be used to refer to the “data”. That is, in the disclosure, the expression “transmit ting a physical channel” may be construed as having the same meaning as the expression “transmitting data or a signal over a physical channel”.

In the following description of the disclosure, upper signaling refers to a signal transfer scheme from a base station to a terminal via a downlink data channel of a physical layer, or from a terminal to a base station via an uplink data channel of a physical layer. The upper signaling may also be understood as radio resource control (RRC) signaling or a media access control (MAC) control element (CE).

In the following description of the disclosure, terms and names defined in the 3rd generation partnership project new radio (3GPP NR) or 3GPP long term evolution (3GPP LTE) standards will be used for the sake of descriptive convenience. However, the disclosure is not limited by these terms and names, and may be applied in the same way to systems that conform other standards. In the disclosure, the term “gNB” may be interchangeably used with the term “eNB” for the sake of descriptive convenience. That is, a base station described as “eNB” may refer to “gNB”. Furthermore, the term “terminal” may refer to not only a mobile phone, an MTC device, an NB-IoT device, and a sensor, but also other wireless communication devices.

In the following description, a base station (BS) is an entity that allocates resources to terminals, and may be at least one of a gNode B (gNB), an eNode B (eNB), a Node B, a wireless access unit, a base station controller, and a node on a network. A terminal may include a user equipment (UE), a mobile station (MS), a cellular phone, a smartphone, a computer, or a multimedia system capable of performing a communication function. Of course, examples of the base station and the terminal are not limited to those mentioned above.

In particular, the disclosure may be applied to 3GPP NR (5th generation mobile communication standard). In addition, the disclosure may be applied to intelligent services (e.g., smart homes, smart buildings, smart cities, smart cars or connected cars, healthcare, digital education, retail business, security and safety-related services, etc.) on the basis of 5G communication technology and IoT-related technology. In the disclosure, the term “eNB” may be interchangeably used with the term “gNB” for the sake of descriptive convenience. That is, a base station described as “eNB” may refer to “gNB”. In addition, the term “terminal” may refer to not only mobile phones, NB-IoT devices, and sensors, but also any other wireless communication devices.

A wireless communication system is advancing to a broadband wireless communication system for providing high-speed and high-quality packet data services using communication standards, such as high-speed packet access (HSPA) of 3GPP, LTE (long-term evolution or evolved universal terrestrial radio access (E-UTRA)), LTE-Advanced (LTE-A), LTE-Pro, high-rate packet data (HRPD) of 3GPP2, ultra-mobile broadband (UMB), IEEE 802.16e, and the like, as well as typical voice-based services.

As a typical example of the broadband wireless communication system, an LTE system employs an orthogonal frequency division multiplexing (OFDM) scheme in a downlink (DL) and employs a single carrier frequency division multiple access (SC-FDMA) scheme in an uplink (UL). The uplink refers to a radio link via which a UE transmits data or control signals to a base station or eNode B, and the downlink refers to a radio link via which the base station transmits data or control signals to the UE. The above multiple access scheme separates data or control information of respective users by allocating and operating time-frequency resources for transmitting the data or control information for each user so as to avoid overlapping each other, that is, so as to establish orthogonality.

Since a 5G communication system, which is a post-LTE communication system, must freely reflect various requirements of users, service providers, and the like, services satisfying various requirements must be supported. The services considered in the 5G communication system include enhanced mobile broadband (eMBB) communication, massive machine-type communication (mMTC), ultra-reliability low-latency communication (URLLC), and the like.

According to some embodiments, eMBB may aim at providing a data rate higher than that supported by existing LTE, LTE-A, or LTE-Pro. For example, in the 5G communication system, eMBB must provide a peak data rate of 20 Gbps in the downlink and a peak data rate of 10 Gbps in the uplink for a single base station. Furthermore, the 5G communication system must provide an increased user-perceived data rate to the UE, as well as the maximum data rate. In order to satisfy such requirements, transmission/reception technologies including a further enhanced multi-input multi-output (MIMO) transmission technique may be required to be improved. In addition, the data rate required for the 5G communication system may be obtained using a frequency bandwidth more than 20 MHz in a frequency band of 3 to 6 GHz or 6 GHz or more, instead of transmitting signals using a transmission bandwidth up to 20 MHz in a band of 2 GHz used in LTE.

In addition, mMTC is being considered to support application services such as the Internet of Things (IoT) in the 5G communication system. mMTC may have requirements, such as support of connection of a large number of UEs in a cell, enhancement coverage of UEs, improved battery time, a reduction in the cost of a UE, and the like, in order to effectively provide the Internet of Things. Since the Internet of Things provides communication functions while being provided to various sensors and various devices, it must support a large number of UEs (e.g., 1,000,000 UEs/km²) in a cell. In addition, the UEs supporting mMTC may require wider coverage than those of other services provided by the 5G communication system because the UEs are likely to be located in a shadow area, such as a basement of a building, which is not covered by the cell due to the nature of the service. The UE supporting mMTC must be configured to be inexpensive, and may require a very long battery life-time such as 10 to 15 years because it is difficult to frequently replace the battery of the UE.

Lastly, URLLC, which is a cellular-based mission-critical wireless communication service, may be used for remote control for robots or machines, industrial automation, unmanned aerial vehicles, remote health care, emergency alert, and the like. Thus, URLLC must provide communication with ultra-low latency and ultra-high reliability. For example, a service supporting URLLC must satisfy an air interface latency of less than 0.5 ms, and may also require a packet error rate of 10-5 or less. Therefore, for the services supporting URLLC, a 5G system must provide a transmit time interval (TTI) shorter than those of other services, and may also require a design for assigning a large number of resources in a frequency band in order to secure reliability of a communication link.

The above-described three services considered in the 5G communication system, that is, eMBB, URLLC, and mMTC, may be multiplexed and transmitted in a single system. In this case, different transmission/reception techniques and transmission/reception parameters may be used between services in order to satisfy different requirements of the respective services. However, mMTC, URLLC, and eMBB as described above are merely an example of different types of services, and service types to which the disclosure is applied are not limited to those mentioned above.

In the following description of embodiments of the disclosure, LTE, LTE-A, LTE Pro, or 5G (or NR, next-generation mobile communication) systems will be described by way of example, but the embodiments of the disclosure may be applied to other communication systems having similar backgrounds or channel types. In addition, based on determinations by those skilled in the art, the embodiments of the disclosure may be applied to other communication systems through some modifications without significantly departing from the scope of the disclosure.

FIG. 1 illustrates the operating scheme of multicast and broadcast service (MBS) communication according to an embodiment of the disclosure.

The MBS communication refers to a scheme of communication in which one transmission device communicates with multiple reception devices in a mobile communication system. Due to such a scheme, MBS communication is also referred to as point-to-multipoint (PTM) communication. In connection with the MBS communication, the transmission device may be a gNB, and each reception device may be a UE. However, the disclosure is not limited thereto, and the transmission device may also be a UE.

The embodiment in FIG. 1 shows an example in which MBS communication is performed assuming that the gNB 110 is a transmission device, and the UEs 120, 130, 140, 150, and 160 are reception devices. Such MBS communication may be broadcast for multiple unspecified reception devices, or may be multicast for multiple specified reception devices. If communication is performed in the multicast type, the gNB may configure only a specific UE to be able to receive corresponding multicast packets. To this end, a set of UEs supposed to perform specific multicast communication may be configured, and such a set of UEs is referred to as a multicast group 170 in the embodiment of FIG. 1. Meanwhile, the scheme of one-to-one communication between a gNB and a UE is referred to as unicast.

UEs in the multicast group may have an identical group-radio network temporary identity (G-RNTI) (separate resource identifier) assigned thereto, and may receive multicast data by decoding a control channel addressed by the G-RNTI. The G-RNTI is an RNTI shared by UEs in the multicast group, and UEs having the G-RNTI assigned thereto may receive radio resources for the MBS service from the gNB. It is assumed in the embodiment of FIG. 1 that UE 1 120, UE 2 130, UE 3 140, and UE 4 150 are configured as one multicast group 170, have a G-RNTI assigned thereto, and thus receive data from the gNB 110 in a multicast type. UE 5 160 is not included in the multicast group 170 and thus has no G-RNTI assigned thereto. Therefore, UE 5 160 cannot receive the data which UE 1 120, UE 2 130, UE 3 140, and UE 4 150 receive from the gNB.

One or more multicast groups 170 may be configured in the coverage of the gNB 110, and each multicast group 170 may be distinguished by each G-RNTI. One UE may have one or more G-RNTIs assigned thereto by the gNB 110. Not only in a connected mode (RRC_connected mode), but also in an RRC inactive mode, the UE may receive multicast data by using the G-RNTI value assigned thereto in the connected mode. The G-RNTI may be included and configured in at least one of an RRC reconfiguration message, an RRC setup message, an RRC reestablishment message, and an RRC release message in the connected mode of the UE. However, the disclosure is not limited thereto, and the G-RNTI may be included as a value which the UE may receive from a system information block (SIB) or a separate multicast control channel (MCCH) and then transmitted from the gNB to the UE. The UE, for which the G-RNTI value is configured as such, may apply the G-RNTI value thereafter.

If the gNB wants to perform multicast in the connected mode, or if the gNB wants to transfer configuration information for multicast communication, including the G-RNTI, to a UE in the connected mode, the gNB may need to transition UEs in the multicast group to the connected mode. As another example, if a UE which currently receives a multicast service in the inactive mode has difficulty in receiving the multicast service in the inactive mode due to a decrease in signal strength or the like, the UE may need to transition to the connected mode. In the embodiment illustrated in FIG. 1, UE 1 120 and UE 2 130 are in the connected mode among the UEs in the multicast group 170, and UE 3 140 and UE 4 150 are in the inactive mode. As such, the gNB may indicate a multicast configuration to UEs, and UEs in the connected mode or inactive mode may receive the multicast service.

A UE in the RRC_connected mode may apply a discontinuous reception (DRX) scheme to reduce power consumption, thereby monitoring a physical downlink control channel (PDCCH) only in the active time of DRX. In connection with DRX in the RRC_connected mode, one DRX may be configured with regard to each DRX group including one or more cells, and the DRX may determine whether or not to monitor RNTIs for unicast transmission and UE's connected state control, such as a cell RNTI (C-RNTI) and a configured scheduling RNTI (CS-RNTI) in the PDCCH. Such DRX may be referred to as unicast DRX. On the other hand, in order for a UE that performs multicast reception to receive a G-RNTI or a G-CS-RNTI assigned to the multicast group, multicast DRX may be configured for the UE separately from the unicast DRX. The multicast DRX may be configured for UEs in the RRC_connected mode and RRC inactive mode. The multicast DRX may be configured for a UE RRC inactive mode by a method using at least one of an RRC release message, an SIB, and an MCCH message. The multicast DRX may be configured for a cell having multicast configured therefor, and a UE operating based on the multicast DRX may determine whether or not to perform control channel monitoring based on RNTIs for unicast transmission and UE's connected state control, such as a G-RNTI and a group configured scheduling RNTI (G-CS-RNTI) in the PDCCH. Specifically, a UE having multicast DRX configured therefor may monitor the PDCCH of the corresponding cell by using a configured RNTI among a G-RNTI and a G-CS-RNTI in the active time of multicast DRX. On the other hand, if it is not the active time of multicast DRX, the UE may not monitor the PDCCH by using a G-RNTI or a G-CS-RNT. In connection with multicast DRX, if at least one of the following conditions is satisfied, the same may be defined as the active time of multicast DRX.
Time during which drx-onDurationTimerPTM is running
Time during which drx-InactivityTimerPTM is running
Time during which drx-RetransmissionTimerDLPTM is running

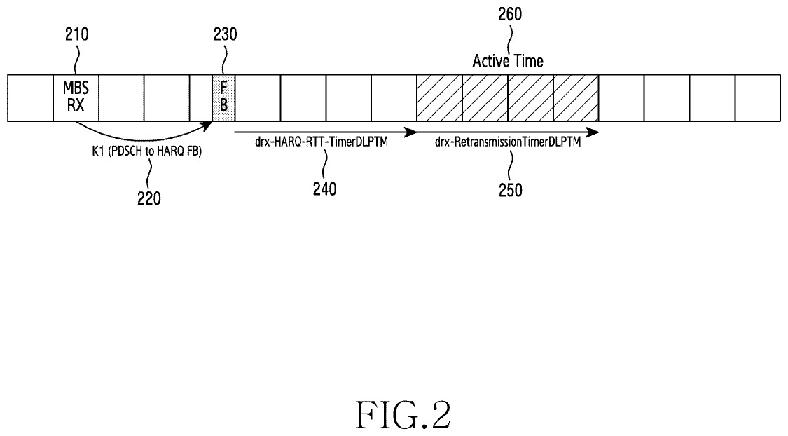

FIG. 2 illustrates a multicast DRX operation of a UE in the RRC_connected mode according to an embodiment of the disclosure.

After receiving multicast data (210), the UE in the RRC_connected mode may transmit HARQ feedback to the gNB to indicate whether the data has been successfully received or not according to a hybrid automatic repeat request (HARQ) procedure (230). In an embodiment, the UE may transmit only negative acknowledgement (NACK) feedback to indicate failed reception (that is, NACK only feedback). The time taken to transmit HARQ feedback after receiving multicast data may be denoted by K1, and the K1 value may be configured at the slot level (220). Specifically, the UE may transmit HARQ feedback by using a physical uplink control channel (PUCCH) resource configured from a slot coming after K1 slots from a slot used to receive a medium access control protocol data unit (MAC PDU) (or transport block (TB)) of multicast data. Candidate groups of the possible K1 value may be configured by an RRC configuration, and the value of one of the candidate groups may be indicated by field PDSCH-to-HARQ feedback Timing Indicator included in downlink control information (DCI) of the PDCCH that indicates scheduling of a MAC PDU (or TB) of multicast data. The gNB may configure candidate groups of the K1 value through an RRC configuration message and may select the value of one of the candidate groups and may indicate the same to the UE through DCI. The UE may then select the K1 value, based thereon.

In the embodiment of FIG. 2, the K1 value is configured to denote three slots such that HARQ feedback has been transmitted after three slots since the timepoint of reception of the MAC PDU of multicast data (210, 220, and 230). In connection with PUCCH resources for transmitting HARQ feedback, if candidate groups of possible PUCCH resources are configured by an RRC configuration, the value of one of the candidate groups may be indicated by a PUCCH resource indicator field included in DCI of the PDCCH channel that indicates scheduling of a MAC PDU (or TB) of multicast data. The gNB may configure candidate groups of PUCCH resources for transmitting HARQ feedback through an RRC configuration message, and may select the value of one of the candidate groups and indicate the same to the UE through DCI. The UE may then transmit HARQ feedback by using the indicated PUCCH resource for transmitting HARQ feedback.

In order to reduce power consumed by a UE which receives multicast data, the gNB may configure multicast DRX for the UE. The multicast DRX may be configured with regard to each G-RNTI of the UE, and the UE may operate according to the multicast DRX configured in the cell for which the corresponding G-RNTI is configured. If multicast DRX is configured so as to correspond to each G-RNTI, values included in the corresponding multicast DRX configuration may include at least one of the DRX cycle length, the on-duration length (drx-onDurationTimerPTM), drx-InactivityTimerPTM, drx-HARQ-RTT-TimerDLPTM length, or drx-RetransmissionTimerDLPTM length. During multicast DRX configuration, the UE may have an on-duration of a predetermined time for each configured DRX cycle, and the on-duration may operate by means of drx-onDurationTimerPTM. When receiving a MAC PDU (or TB) by means of a G-RNTI or a connected G-CS-RNTI, the UE may start drx-InactivityTimerPTM. Moreover, the UE may start drx-HARQ-RTT-TimerDLPTM corresponding to the G-RNTI used to receive data in the first symbol after transmitting HARQ feedback performed in step 230 (240).

If the UE is instructed by the gNB not to transmit HARQ feedback, or if NACK-based HARQ feedback is configured such that feedback is transmitted only in the case of a data reception failure, and if no NACK is generated because data reception is successfully performed, drx-HARQ-RTT-TimerDLPTM may not be started. After expiration of drx-HARQ-RTT-TimerDLPTM, the UE may start drx-RetransmissionTimerDLPTM of multicast DRX regarding the G-RNTI corresponding to the drx-HARQ-RTT-TimerDLPTM (250). The drx-RetransmissionTimerDLPTM may be started only if corresponding multicast data fails to be received successfully (that is, if decoding of the corresponding TB has failed). During the multicast DRX operation, the UE may perform PDCCH monitoring by using the corresponding G-RNTI and G-CS-RNTI only in the active time interval, and may not perform PDCCH monitoring by using the corresponding G-RNTI and G-CS-RNTI outside of the active time interval, thereby reducing power consumption. In connection with multicast DRX, if at least one of the following conditions is satisfied, the same may be defined as the active time.
drx-onDurationTimerPTM is running
drx-InactivityTimerPTM is running
drx-RetransmissionTimerDLPTM is running

In the embodiment of FIG. 2, in a period of time for which drx-RetransmissionTimerDLPTM is running, the UE may perform PDCCH monitoring by using the G-RNTI and G-CS-RNTI in consideration of the fact that the cell for which the G-RNTI is configured in the active time (or by considering that the same is in the active time) (260). This is advantageous in that the gNB is enabled to perform retransmission when drx-RetransmissionTimerDLPTM is running, thereby reducing the HARQ retransmission delay time after performing the previous transmission 210.

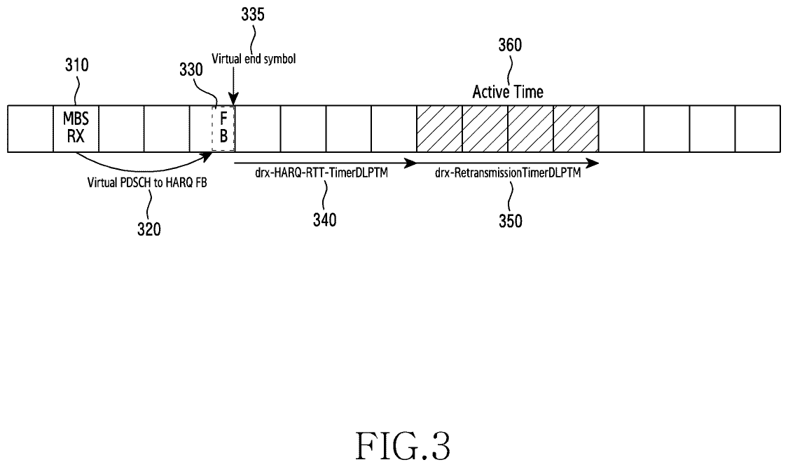

FIG. 3 illustrates a multicast DRX operation of a UE in an RRC inactive mode according to another embodiment of the disclosure.

After receiving multicast data (310), the UE in the RRC inactive mode cannot transmit HARQ feedback to the gNB to indicate whether the data has been successfully received or not. This is because the UE in the RRC inactive mode does not maintain uplink synchronization with the gNB and has no PUCCH resources configured therefor to transmit HARQ feedback (330). Therefore, with regard to the UE in the RRC inactive mode, it is unnecessary to configure the K1 value (for example, 220 in FIG. 2) to indicate the time taken to transmit HARQ feedback after receiving multicast data. On the other hand, if a UE in an RRC_connected mode has failed in multicast reception, the gNB may receive HARQ feedback from the UE in the RRC connected mode and may perform HARQ retransmission, based thereon.

Meanwhile, according to an embodiment, the gNB may perform arbitrary retransmission even if no HARQ feedback is received from the UE (blind retransmission). In such a case, even in the case of a failure to receive multicast data (310), the UE in the RRC inactive mode may receive data retransmitted thereafter, thereby improving the quality of the multicast service. To this end, drx-HARQ-RTT-TimerDLPTM and drx-RetransmissionTimerDLPTM needs to be configured for the UE in the RRC inactive mode so as to define a procedure for facilitating multicast transmission/reception even in an environment having no HARQ feedback.

The embodiment in FIG. 3 corresponds to a method in which the UE in the RRC inactive mode transmits no HARQ feedback to the gNB, but designates (or determines) a virtual HARQ feedback resource location, thereby starting drx-HARQ-RTT-TimerDLPTM after the virtual HARQ feedback resource location. Specifically, the UE may consider (or assume) that HARQ feedback is transmitted in a PUCCH physical channel resource configured in a slot coming after predetermined slots (for example, virtual K1) from the slot used to receive a MAC PDU (or TB) of multicast data. The virtual K1 value may be determined by configuring candidate groups of the possible K1 value by an RRC configuration (for example, RRC release message or MCCH) and then selecting and indicating the value of one of the candidate groups by field PDSCH-to-HARQ_feedback Timing Indicator of DCI of the PDCCH channel that indicates scheduling of a MAC PDU (or TB) of multicast data. The gNB may configure candidate groups of the virtual K1 value through an RRC configuration (for example, RRC release message or MCCH), and may select the value of one of the candidate groups and indicate the same to the UE through DCI. The UE may select a virtual K1 value, based thereon.

The embodiment of FIG. 3 illustrates a situation based on an assumption that the virtual K1 value is configured to denote three slots (320) such that there is HARQ feedback after three slots since the timepoint at which the UE receives the MAC PDU of multicast data (330). Moreover, the timepoint of the PUCCH resource used to transmit HARQ feedback may be virtually configured for the UE. It is unnecessary to configure all PUCCH resource candidates for the virtual PUCCH resource, and the gNB may configure the timepoint (for example, symbol number 335) at which the virtual PUCCH resource for virtual HARQ feedback ends in the slot necessary for the multicast DRX operation, for the UE. The gNB may configure candidate groups of a possible PUCCH resource (for example, the symbol number at which the PUCCH resource ends) through an RRC configuration (for example, RRC release message or MCCH), and may select and indicate one of values of the candidate groups through a PUCCH resource indicator field included in DCI of the PDCCH that indicates scheduling of a MAC PDU (or TB) of multicast data. The gNB may configure candidate groups of a PUCCH resource (for example, the symbol number at which the PUCCH resource ends) which is used to transmit (or which is considered or assumed to be used to transmit) HARQ feedback through an RRC configuration message, and may select the value of one of the candidate groups and indicate the same to the UE through DCI. The UE may determine the timepoint at which drx-HARQ_RTT-TimerDLPTM 340 starts, based thereon.

According to an embodiment, the virtual K1 value (that is, the slot length from a PDSCH to virtual HARQ feedback) 320 may be configured through an RRC release message or MCCH message transmitted to the UE by the gNB. Alternatively, the gNB may configure the virtual K1 value for the UE as one value through the PDSCH-to-HARQ_feedback Timing Indicator field of DCI.

According to an embodiment, virtual PUCCH resource 330 information (for example, the symbol number 335 at which the virtual PUCCH resource ends) may be configured in an RRC release message or MCCH message transmitted to the UE by the gNB. Alternatively, the virtual K1 value may be configured by the gNB as one value for the UE in the PUCCH resource indicator field of DCI.

In order to reduce power consumed by a UE which receives multicast data, the gNB may configure multicast DRX for the UE. The multicast DRX may be configured with regard to each G-RNTI of the UE, and the UE may operate according to the multicast DRX configured in the cell for which the corresponding G-RNTI is configured. If multicast DRX is configured so as to correspond to each G-RNTI, values included in the corresponding multicast DRX configuration may include at least one of the DRX cycle length, the on-duration length (drx-onDurationTimerPTM), drx-InactivityTimerPTM, drx-HARQ-RTT-TimerDLPTM length, or drx-RetransmissionTimerDLPTM length. During multicast DRX configuration, the UE may have an on-duration of a predetermined time for each configured DRX cycle, and the on-duration may operate by means of drx-onDurationTimerPTM. When receiving a MAC PDU (or TB) by means of a G-RNTI or a connected G-CS-RNTI, the UE may start drx-InactivityTimerPTM. Moreover, the UE may start drx-HARQ-RTT-TimerDLPTM corresponding to the G-RNTI used to receive data in the first symbol after a virtual HARQ feedback resource (for example, the symbol number at which the virtual PUCCH resource ends) in step 330 (340).

According to the embodiment of FIG. 3, a UE which does not transmit HARQ feedback may start drx-HARQ-RTT-TimerDLPTM. In an embodiment, drx-HARQ-RTT-TimerDLPTM may be started only if the UE has failed to successfully receive multicast data (that is, if failed to decode the corresponding TB). After expiration of drx-HARQ-RTT-TimerDLPTM, the UE may start drx-Retransmission TimerDLPTM of multicast DRX regarding the G-RNTI corresponding to the drx-HARQ-RTT-TimerDLPTM (350). The drx-RetransmissionTimerDLPTM may be started only if corresponding multicast data is not successfully received (that is, if decoding of the corresponding TB has failed). During the multicast DRX operation, the UE may perform PDCCH monitoring by using the corresponding G-RNTI and G-CS-RNTI only in the active time interval, and may not perform PDCCH monitoring by using the corresponding G-RNTI and G-CS-RNTI outside of the active time interval, thereby reducing power consumption. In connection with multicast DRX, if at least one of the following conditions is satisfied, the same may be defined as the active time.
drx-onDurationTimerPTM is running
drx-InactivityTimerPTM is running
drx-RetransmissionTimerDLPTM is running

In the embodiment of FIG. 3, in a period of time for which drx-RetransmissionTimerDLPTM is running, the UE may perform PDCCH monitoring by using the G-RNTI (and G-CS-RNTI) in consideration of the fact that the cell for which the G-RNTI is configured in the active time (or by considering that the same is in the active time) (360). This is advantageous in that the gNB is enabled to perform retransmission when drx-RetransmissionTimerDLPTM is running, thereby reducing the HARQ retransmission delay time after performing the previous transmission 310, and enabling the UE in the RRC inactive mode to receive the retransmission.

Although it has been assumed in the embodiment of FIG. 3 that the UE in the RRC inactive mode, which does not transmit HARQ feedback, performs a multicast DRX operation, the embodiment of FIG. 3 may also be applied to an operation in which a UE in the RRC_connected mode transmits drx-HARQ-RTT-TimerDLPTM regardless of HARQ feedback transmission.

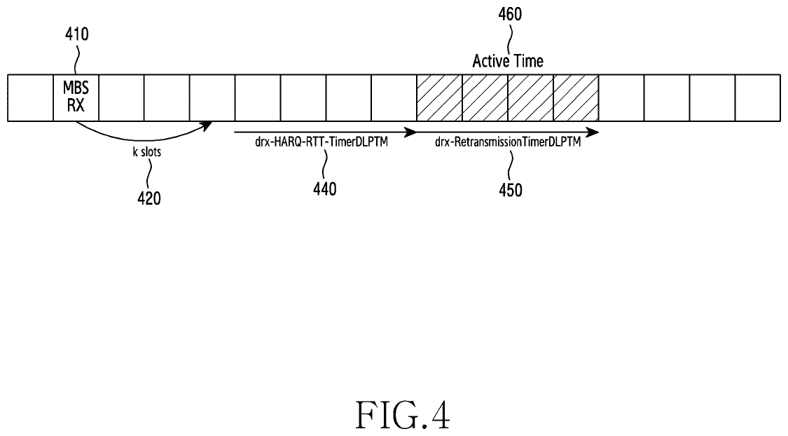

FIG. 4 illustrates a multicast DRX operation of a UE in an RRC inactive mode according to an embodiment of the disclosure.

After receiving multicast data (410), the UE in the RRC inactive mode cannot transmit HARQ feedback to the gNB to indicate whether the data has been successfully received or not. This is because the UE in the RRC inactive mode does not maintain uplink synchronization with the gNB and has no PUCCH resources configured therefor to transmit HARQ feedback. Therefore, with regard to the UE in the RRC inactive mode, it is unnecessary to configure the K1 value (for example, 220 in FIG. 2) to indicate the time taken to transmit HARQ feedback after receiving multicast data. On the other hand, if a UE in an RRC connected mode has failed in multicast reception, the gNB may receive HARQ feedback from the UE in the RRC_connected mode and may perform HARQ retransmission, based thereon.

Meanwhile, according to an embodiment, the gNB may perform arbitrary retransmission even if no HARQ feedback is received from the UE (blind retransmission). In such a case, even in the case of a failure to receive multicast data (410), the UE in the RRC inactive mode may receive data retransmitted thereafter, thereby improving the quality of the multicast service. To this end, drx-HARQ-RTT-TimerDLPTM and drx-Retransmission TimerDLPTM needs to be configured for the UE in the RRC inactive mode so as to define a procedure for facilitating multicast transmission/reception even in an environment having no HARQ feedback.

The embodiment in FIG. 4 corresponds to a method in which the UE in the RRC inactive mode starts drx-HARQ-RTT-TimerDLPTM after predetermined slots. Specifically, the UE may start drx-HARQ-RTT-TimerDLPTM immediately after k slots 420 determined after the slot used to receive a MAC PDU (or TB) of multicast data (440). For the slot k value, candidate groups of possible K values may be configured through an RRC configuration (for example, RRC release message or MCCH), one of values of the candidate groups may be indicated through the PDSCH-to-HARQ_feedback Timing Indicator field of DCI of the PDCCH channel that indicates scheduling of a MAC PDU (or TB) of multicast data. The gNB may configure candidate groups of the slot k value through an RRC configuration (for example, RRC release message or MCCH) message, and may select the value of one of the candidate groups and indicate the same to the UE through DCI. The UE may select a slot k value, based thereon. The embodiment of FIG. 4 illustrates a situation wherein the virtual k value is configured to denote three slots (420) such that drx-HARQ-RTT-TimerDLPTM is started at a timepoint at which three slots are over (that is, at a timepoint at which the next slot starts after three slots are over) from the timepoint at which the UE receives the MAC PDU of multicast data. The UE may determine the timepoint at which drx-HARQ RTT-TimerDLPTM 440 starts, based thereon.

According to an embodiment, the slot k value 420 may be configured through an RRC release message or MCCH message transmitted to the UE by the gNB. Alternatively, the gNB may configure the slot k value for the UE as one value through the PDSCH-to-HARQ_feedback Timing Indicator field of DCI.

In order to reduce power consumed by a UE which receives multicast data, the gNB may configure multicast DRX for the UE. The multicast DRX may be configured with regard to each G-RNTI of the UE, and the UE may operate according to the multicast DRX configured in the cell for which the corresponding G-RNTI is configured. If multicast DRX is configured so as to correspond to each G-RNTI, values included in the corresponding multicast DRX configuration may include at least one of the DRX cycle length, the on-duration length (drx-onDurationTimerPTM), drx-InactivityTimerPTM, drx-HARQ-RTT-TimerDLPTM length, or drx-RetransmissionTimerDLPTM length. During multicast DRX configuration, the UE may have an on-duration of a predetermined time for each configured DRX cycle, and the on-duration may operate by means of drx-onDurationTimerPTM. When receiving a MAC PDU (or TB) by means of a G-RNTI or a connected G-CS-RNTI, the UE may start drx-InactivityTimerPTM. Moreover, the UE may start drx-HARQ-RTT-TimerDLPTM corresponding to the G-RNTI used to receive data in the first symbol after k slots 420 (440).

According to the embodiment of FIG. 4, a UE which does not transmit HARQ feedback may start drx-HARQ-RTT-TimerDLPTM. In an embodiment, drx-HARQ-RTT-TimerDLPTM may be started only if the UE has failed to successfully receive multicast data (that is, if failed to decode the corresponding TB). After expiration of drx-HARQ-RTT-TimerDLPTM, the UE may start drx-Retransmission TimerDLPTM of multicast DRX regarding the G-RNTI corresponding to the drx-HARQ-RTT-TimerDLPTM (450). The drx-RetransmissionTimerDLPTM may be started only if corresponding multicast data is not successfully received (that is, if decoding of the corresponding TB has failed). During the multicast DRX operation, the UE may perform PDCCH monitoring by using the corresponding G-RNTI and G-CS-RNTI only in the active time interval, and may not perform PDCCH monitoring by using the corresponding G-RNTI and G-CS-RNTI outside of the active time interval, thereby reducing power consumption. In connection with multicast DRX, if at least one of the following conditions is satisfied, the same may be defined as the active time.
drx-onDurationTimerPTM is running
drx-InactivityTimerPTM is running
drx-RetransmissionTimerDLPTM is running

In the embodiment of FIG. 4, in a period of time for which drx-RetransmissionTimerDLPTM is running, the UE may perform PDCCH monitoring by using the G-RNTI (and G-CS-RNTI) in consideration of the fact that the cell for which the G-RNTI is configured in the active time (or by considering that the same is in the active time) (460). This is advantageous in that the gNB is enabled to perform retransmission when drx-RetransmissionTimerDLPTM is running, thereby reducing the HARQ retransmission delay time after performing the previous transmission 410, and enabling the UE in the RRC inactive mode to receive the retransmission.

Although it has been assumed in the embodiment of FIG. 4 that the UE in the RRC inactive mode, which does not transmit HARQ feedback, performs a multicast DRX operation, the embodiment of FIG. 4 may also be applied to an operation in which a UE in the RRC connected mode transmits drx-HARQ-RTT-TimerDLPTM regardless of HARQ feedback transmission.

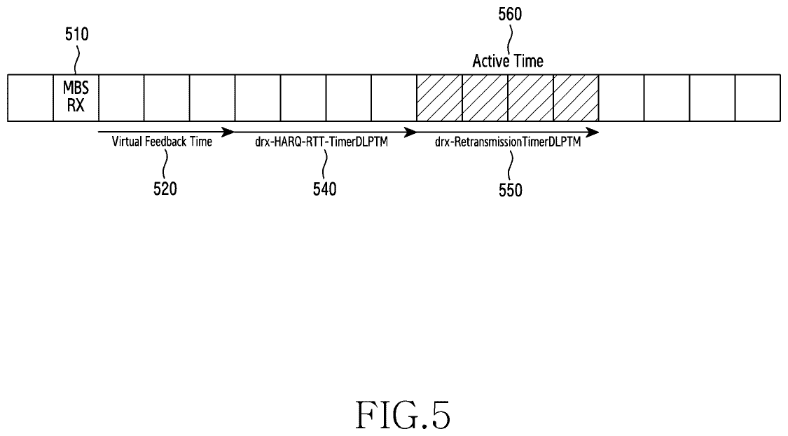

FIG. 5 illustrates a multicast DRX operation of a UE in an RRC inactive mode according to an embodiment of the disclosure.

After receiving multicast data (510), the UE in the RRC inactive mode cannot transmit HARQ feedback to the gNB to indicate whether the data has been successfully received or not. This is because the UE in the RRC inactive mode does not maintain uplink synchronization with the gNB and has no PUCCH resources configured therefor to transmit HARQ feedback. Therefore, with regard to the UE in the RRC inactive mode, it is unnecessary to configure the K1 value (for example, 220 in FIG. 2) to indicate the time taken to transmit HARQ feedback after receiving multicast data. On the other hand, if a UE in an RRC_connected mode has failed in multicast reception, the gNB may receive HARQ feedback from the UE in the RRC connected mode and may perform HARQ retransmission, based thereon.

Meanwhile, according to an embodiment, the gNB may perform arbitrary retransmission even if no HARQ feedback is received from the UE (blind retransmission). In such a case, even in the case of a failure to receive multicast data (510), the UE in the RRC inactive mode may receive data retransmitted thereafter, thereby improving the quality of the multicast service. To this end, drx-HARQ-RTT-TimerDLPTM and drx-Retransmission TimerDLPTM needs to be configured for the UE in the RRC inactive mode so as to define a procedure for facilitating multicast transmission/reception even in an environment having no HARQ feedback.

The embodiment in FIG. 5 corresponds to a method in which the UE in the RRC inactive mode starts drx-HARQ-RTT-TimerDLPTM after predetermined slots. Specifically, the UE may apply a virtual feedback time from the next symbol immediately after the radio resource (for example, physical downlink shared channel (PDSCH)) used to receive a MAC PDU (or TB) of multicast data is ended (or from the next slot in which the radio resource (for example, PDSCH) is ended) (520). The virtual feedback time may refer to a time for which the UE in the RRC inactive mode waits to start drx-HARQ-RTT-TimerDLPTM in consideration of the time needed by the UE in the RRC inactive mode to transmit HARQ feedback. The virtual feedback time may be implemented as a timer operation, and the UE may start a timer for applying the virtual feedback time to the next symbol (or the next slot) immediately after the resource used to receive the MAC PDU of multicast data is ended. Thereafter, the UE may start drx-HARQ-RTT-TimerDLPTM at a timepoint at which the virtual feedback time is ended (or at a timepoint of expiration of the timer for applying the virtual feedback time) (540). For the virtual feedback time value, possible candidate groups may be configured through an RRC configuration (for example, RRC release message or MCCH), and one of values of the candidate groups may be selected and indicated through the PDSCH-to-HARQ_feedback Timing Indicator field of DCI of the PDCCH channel that indicates scheduling of a MAC PDU (or TB) of multicast data. The gNB may configure candidate groups of the virtual feedback time value for the UE through an RRC configuration (for example, RRC release message or MCCH) message, and may select the value of one of the candidate groups and indicate the same to the UE through DCI. The UE may select a virtual feedback time value, based thereon. The embodiment of FIG. 5 illustrates a situation wherein the virtual feedback time is configured to denote three slots (520) such that drx-HARQ-RTT-TimerDLPTM is started at a timepoint at which three slots are over (that is, at a timepoint at which the next slot starts after three slots are over) from the timepoint at which the UE receives the MAC PDU of multicast data. The UE may determine the timepoint at which drx-HARQ RTT-TimerDLPTM 540 starts, based thereon.

According to an embodiment, the virtual feedback time value 520 may be configured through an RRC release message or MCCH message transmitted to the UE by the gNB. Alternatively, the gNB may configure the virtual feedback time value for the UE as one value through the PDSCH-to-HARQ_feedback Timing Indicator field of DCI.

In order to reduce power consumed by a UE which receives multicast data, the gNB may configure multicast DRX for the UE. The multicast DRX may be configured with regard to each G-RNTI of the UE, and the UE may operate according to the multicast DRX configured in the cell for which the corresponding G-RNTI is configured. If multicast DRX is configured so as to correspond to each G-RNTI, values included in the corresponding multicast DRX configuration may include at least one of the DRX cycle length, the on-duration length (drx-onDurationTimerPTM), drx-InactivityTimerPTM, drx-HARQ-RTT-TimerDLPTM length, or drx-RetransmissionTimerDLPTM length. During multicast DRX configuration, the UE may have an on-duration of a predetermined time for each configured DRX cycle, and the on-duration may operate by means of drx-onDurationTimerPTM. When receiving a MAC PDU (or TB) by means of a G-RNTI or a connected G-CS-RNTI, the UE may start drx-InactivityTimerPTM. Moreover, the UE may start drx-HARQ-RTT-TimerDLPTM corresponding to the G-RNTI used to receive data immediately after the virtual feedback time 520 is ended (540).

According to the embodiment of FIG. 5, a UE which does not transmit HARQ feedback may start drx-HARQ-RTT-TimerDLPTM. In an embodiment, drx-HARQ-RTT-TimerDLPTM may be started only if the UE has failed to successfully receive multicast data (that is, if failed to decode the corresponding TB). If the virtual feedback time is implemented by a timer, the UE may start the timer for applying the virtual feedback time only if the UE has failed to successfully receive multicast data (that is, if failed to decode the corresponding TB). After expiration of drx-HARQ-RTT-TimerDLPTM, the UE may start drx-Retransmission TimerDLPTM of multicast DRX regarding the G-RNTI corresponding to the drx-HARQ-RTT-TimerDLPTM (550). The drx-RetransmissionTimerDLPTM may be started only if corresponding multicast data is not successfully received (that is, if decoding of the corresponding TB has failed). During the multicast DRX operation, the UE may perform PDCCH monitoring by using the corresponding G-RNTI and G-CS-RNTI only in the active time interval, and may not perform PDCCH monitoring by using the corresponding G-RNTI and G-CS-RNTI outside of the active time interval, thereby reducing power consumption. In connection with multicast DRX, if at least one of the following conditions is satisfied, the same may be defined as the active time.
drx-onDurationTimerPTM is running
drx-InactivityTimerPTM is running
drx-RetransmissionTimerDLPTM is running

In the embodiment of FIG. 5, in a period of time for which drx-RetransmissionTimerDLPTM is running, the UE may perform PDCCH monitoring by using the G-RNTI (and G-CS-RNTI) in consideration of the fact that the cell for which the G-RNTI is configured in the active time (or by considering that the same is in the active time) (560). This is advantageous in that the gNB is enabled to perform retransmission when drx-RetransmissionTimerDLPTM is running, thereby reducing the HARQ retransmission delay time after performing the previous transmission 510, and enabling the UE in the RRC inactive mode to receive the retransmission. The virtual feedback time described in the embodiment of FIG. 5 may be configured by using at least one of a symbol unit, a slot unit, a subframe unit, a millisecond unit, and a microsecond unit, or may be configured by using other time units.

Although it has been assumed in the embodiment of FIG. 5 that the UE in the RRC inactive mode, which does not transmit HARQ feedback, performs a multicast DRX operation, the embodiment of FIG. 5 may also be applied to an operation in which a UE in the RRC connected mode transmits drx-HARQ-RTT-TimerDLPTM regardless of HARQ feedback transmission.

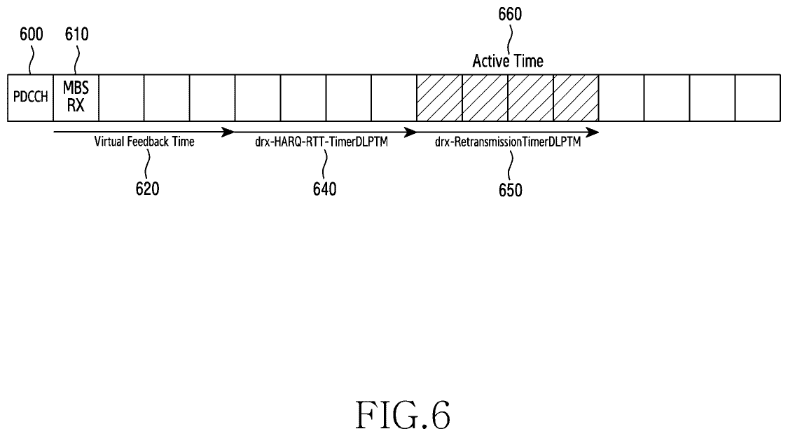

FIG. 6 illustrates a multicast DRX operation of a UE in an RRC inactive mode according to an embodiment of the disclosure.

After receiving multicast data (610), the UE in the RRC inactive mode cannot transmit HARQ feedback to the gNB to indicate whether the data has been successfully received or not. This is because the UE in the RRC inactive mode does not maintain uplink synchronization with the gNB and has no PUCCH resources configured therefor to transmit HARQ feedback. Therefore, with regard to the UE in the RRC inactive mode, it is unnecessary to configure the K1 value (for example, 220) to indicate the time taken to transmit HARQ feedback after receiving multicast data. On the other hand, if a UE in an RRC_connected mode has failed in multicast reception, the gNB may receive HARQ feedback from the UE in the RRC_connected mode and may perform HARQ retransmission, based thereon.

Meanwhile, according to an embodiment, the gNB may perform arbitrary retransmission even if no HARQ feedback is received from the UE (blind retransmission). In such a case, even in the case of a failure to receive multicast data (610), the UE in the RRC inactive mode may receive data retransmitted thereafter, thereby improving the quality of the multicast service. To this end, drx-HARQ-RTT-TimerDLPTM and drx-Retransmission TimerDLPTM needs to be configured for the UE in the RRC inactive mode so as to define a procedure for facilitating multicast transmission/reception even in an environment having no HARQ feedback.

The embodiment in FIG. 6 corresponds to a method in which the UE in the RRC inactive mode starts drx-HARQ-RTT-TimerDLPTM after predetermined slots. Specifically, the UE may apply a virtual feedback time from the next symbol immediately after the PDCCH resource 600 that indicates reception of multicast data is ended (or from the next slot in which the PDCCH resource is ended) (620). The virtual feedback time may refer to a time for which the UE in the RRC inactive mode waits to start drx-HARQ-RTT-TimerDLPTM in consideration of the time needed by a UE in the RRC_connected mode to transmit HARQ feedback. The virtual feedback time may be implemented as a timer operation, and the UE may start a timer for applying the virtual feedback time from the next symbol immediately after the PDCCH resource that indicates reception of multicast data is ended (or from the next slot in which the PDCCH resource is ended). Thereafter, the UE may start drx-HARQ-RTT-TimerDLPTM at a timepoint at which the virtual feedback time is ended (or at a timepoint of expiration of the timer for applying the virtual feedback time) (640). For the virtual feedback time value, possible candidate groups may be configured through an RRC configuration (for example, RRC release message or MCCH), and one of values of the candidate groups may be selected and indicated through the PDSCH-to-HARQ_feedback Timing Indicator field of DCI of the PDCCH channel that indicates scheduling of a MAC PDU (or TB) of multicast data. The gNB may configure candidate groups of the virtual feedback time value for the UE through an RRC configuration (for example, RRC release message or MCCH) message, and may select the value of one of the candidate groups and indicate the same to the UE through DCI. The UE may select a virtual feedback time value, based thereon. The embodiment of FIG. 6 illustrates a situation wherein the virtual feedback time is configured to denote four slots (620) such that drx-HARQ-RTT-TimerDLPTM is started at a timepoint at which four slots are over (that is, at a timepoint at which the next slot starts after four slots are over) from the timepoint at which the PUCCH that indicates reception of multicast data is ended. The UE may determine the timepoint at which drx-HARQ_RTT-TimerDLPTM 640 starts, based thereon.

According to an embodiment, the virtual feedback time value 620 may be configured through an RRC release message or MCCH message transmitted to the UE by the gNB. Alternatively, the gNB may configure the virtual feedback time value for the UE as one value through the PDSCH-to-HARQ_feedback Timing Indicator field of DCI.

In order to reduce power consumed by a UE which receives multicast data, the gNB may configure multicast DRX for the UE. The multicast DRX may be configured with regard to each G-RNTI of the UE, and the UE may operate according to the multicast DRX configured in the cell for which the corresponding G-RNTI is configured. If multicast DRX is configured so as to correspond to each G-RNTI, values included in the corresponding multicast DRX configuration may include at least one of the DRX cycle length, the on-duration length (drx-onDurationTimerPTM), drx-InactivityTimerPTM, drx-HARQ-RTT-TimerDLPTM length, or drx-RetransmissionTimerDLPTM length. During multicast DRX configuration, the UE may have an on-duration of a predetermined time for each configured DRX cycle, and the on-duration may operate by means of drx-onDurationTimerPTM. When receiving a MAC PDU (or TB) by means of a G-RNTI or a connected G-CS-RNTI, the UE may start drx-InactivityTimerPTM. Moreover, the UE may start drx-HARQ-RTT-TimerDLPTM corresponding to the G-RNTI used to receive data immediately after the virtual feedback time 620 is ended (640).

According to the embodiment of FIG. 6, a UE which does not transmit HARQ feedback may start drx-HARQ-RTT-TimerDLPTM. In an embodiment, drx-HARQ-RTT-TimerDLPTM may be started only if the UE has failed to successfully receive multicast data (that is, if failed to decode the corresponding TB). If the virtual feedback time is implemented by a timer, the UE may start the timer for applying the virtual feedback time only if the UE has failed to successfully receive multicast data (that is, if failed to decode the corresponding TB). If multicast data is successfully received although the timer for applying the virtual feedback time has already started, the UE may stop the timer. After expiration of drx-HARQ-RTT-TimerDLPTM, the UE may start drx-Retransmission TimerDLPTM of multicast DRX regarding the G-RNTI corresponding to the drx-HARQ-RTT-TimerDLPTM (650). The drx-RetransmissionTimerDLPTM may be started only if corresponding multicast data is not successfully received (that is, if decoding of the corresponding TB has failed). During the multicast DRX operation, the UE may perform PDCCH monitoring by using the corresponding G-RNTI and G-CS-RNTI only in the active time interval, and may not perform PDCCH monitoring by using the corresponding G-RNTI and G-CS-RNTI outside of the active time interval, thereby reducing power consumption. In connection with multicast DRX, if at least one of the following conditions is satisfied, the same may be defined as the active time.
drx-onDurationTimerPTM is running
drx-InactivityTimerPTM is running
drx-RetransmissionTimerDLPTM is running

In the embodiment of FIG. 6, in a period of time for which drx-RetransmissionTimerDLPTM is running, the UE may perform PDCCH monitoring by using the G-RNTI (and G-CS-RNTI) in consideration of the fact that the cell for which the G-RNTI is configured in the active time (or by considering that the same is in the active time) (660). This is advantageous in that the gNB is enabled to perform retransmission when drx-RetransmissionTimerDLPTM is running, thereby reducing the HARQ retransmission delay time after performing the previous transmission 610, and enabling the UE in the RRC inactive mode to receive the retransmission. The virtual feedback time described in the embodiment of FIG. 6 may be configured by using at least one of a symbol unit, a slot unit, a subframe unit, a millisecond unit, and a microsecond unit, or may be configured by using other time units.

Although it has been assumed in the embodiment of FIG. 6 that the UE in the RRC inactive mode, which does not transmit HARQ feedback, performs a multicast DRX operation, the embodiment of FIG. 6 may also be applied to an operation in which a UE in the RRC connected mode transmits drx-HARQ-RTT-TimerDLPTM regardless of HARQ feedback transmission.

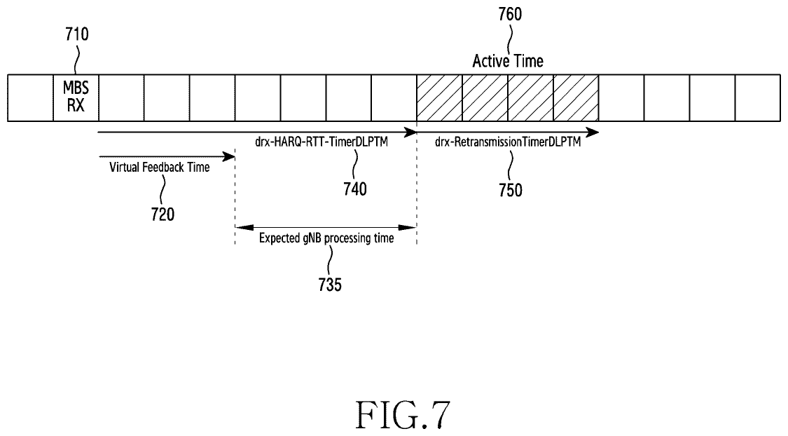

FIG. 7 illustrates a multicast DRX operation of a UE in an RRC inactive mode according to an embodiment of the disclosure.

After receiving multicast data (710), the UE in the RRC inactive mode cannot transmit HARQ feedback to the gNB to indicate whether the data has been successfully received or not. This is because the UE in the RRC inactive mode does not maintain uplink synchronization with the gNB and has no PUCCH resources configured therefor to transmit HARQ feedback. Therefore, with regard to the UE in the RRC inactive mode, it is unnecessary to configure the K1 value (for example, 220 in FIG. 2) to indicate the time taken to transmit HARQ feedback after receiving multicast data. On the other hand, if a UE in an RRC_connected mode has failed in multicast reception, the gNB may receive HARQ feedback from the UE in the RRC_connected mode and may perform HARQ retransmission, based thereon.

Meanwhile, according to an embodiment, the gNB may perform arbitrary retransmission even if no HARQ feedback is received (blind retransmission). In such a case, even in the case of a failure to receive multicast data (710), the UE in the RRC inactive mode may receive data retransmitted thereafter, thereby improving the quality of the multicast service. To this end, drx-HARQ-RTT-TimerDLPTM and drx-RetransmissionTimerDLPTM needs to be configured for the UE in the RRC inactive mode so as to define a procedure for facilitating multicast transmission/reception even in an environment having no HARQ feedback.

The embodiment in FIG. 7 corresponds to a method in which the UE in the RRC inactive mode starts a drx-HARQ-RTT-TimerDLPTM timer by using a separate drx-HARQ-RTT-TimerDLPTM value. The UE in the RRC inactive mode does not transmit HARQ feedback, but may determine the time length of the drx-HARQ-RTT-TimerDLPTM timer, including a virtual feedback time 720, in consideration of the HARQ feedback time (740). To the end, the length of the drx-HARQ-RTT-TimerDLPTM timer may be determined in consideration of both the virtual feedback time 720 and the expected gNB processing time 735 from HARQ feedback to retransmission resource assignment. In an example, the length of the drx-HARQ-RTT-TimerDLPTM timer may be configured to the sum of the virtual feedback time 720 and the expected gNB processing time 735 (740). The UE in the RRC inactive mode may start drx-HARQ-RTT-TimerDLPTM after configuring the drx-HARQ-RTT-TimerDLPTM value to be a value (for example, the sum) that considers both the virtual feedback time and the expected gNB processing time immediately before starting drx-HARQ-RTT-TimerDLPTM. The UE may start a drx-HARQ-RTT-TimerDLPTM timer by applying the above value from the next symbol immediately after the radio resource (for example, PDSCH resource) used to receive a MAC PDU (or TB) of multicast data is ended (or from the next slot in which the radio resource (for example, PDSCH resource) is ended) (740). In an embodiment, the expected gNB processing time may be configured to be included in the drx-HARQ-RTT-TimerDLPTM value itself through an RRC release message or MCCH message, and a separate timer (for example, drx-HARQ-RTT-TimerDLPTM-Inactive) may be configured as the sum of the drx-HARQ-RTT-TimerDLPTM value and the virtual feedback time.

According to an embodiment, the gNB may configure possible candidate groups regarding the virtual feedback time value for the UE through an RRC configuration (for example, RRC release message or MCCH), and may select one of values of the candidate groups and indicate the same to the UE through the PDSCH-to-HARQ_feedback Timing Indicator field of DCI of the PDCCH channel that indicates scheduling of a MAC PDU (or TB) of multicast data. The gNB may configure candidate groups of the virtual feedback time value through an RRC configuration (for example, RRC release message or MCCH) message, and may select the value of one of the candidate groups and indicate the same to the UE through DCI. The UE may select a virtual feedback time value, based thereon.

According to an embodiment, the virtual feedback time may be separately configured by using a symbol unit. For example, the entire virtual feedback time may be configured to be the sum of a virtual feedback time indicated in the PDSCH-to-HARQ_feedback Timing Indicator field and a symbol-unit virtual feedback time in a PUCCH resource indicator field. In connection with the symbol-unit virtual feedback time, candidate groups of the virtual feedback time value may be configured through an RRC configuration (for example, RRC release message or MCCH message), and the value of one of the candidate groups may be selected and indicated to the UE through DCI. The UE may select a symbol-unit virtual feedback time value, based thereon.

In an embodiment, the virtual feedback time 720 may be configured in an RRC release message or MCCH message transmitted to the UE by the gNB. Alternatively, the virtual feedback time may be configured by the gNB as one value for the UE in the PDSCH-to-HARQ_feedback Timing Indicator field of DCI.

In an embodiment, the symbol-unit virtual feedback time may be configured in an RRC release message or MCCH message transmitted to the UE by the gNB. Alternatively, the symbol-unit virtual feedback time may be configured by the gNB as one value for the UE in the PUCCH resource indicator field of DCI.

In the embodiment illustrated in FIG. 7, the virtual feedback time is configured to correspond to three slots (720), and the expected gNB processing time is configured to correspond to four slots (735). Therefore, the entire time length of drx-HARQ-RTT-TimerDLPTM may correspond to seven slots (740). Accordingly, drx-HARQ-RTT-TimerDLPTM may run during a seven-slot length after the timepoint 710 at which the UE receives the MAC PDU of multicast data (740).

In order to reduce power consumed by a UE which receives multicast data, the gNB may configure multicast DRX for the UE. The multicast DRX may be configured with regard to each G-RNTI of the UE, and the UE may operate according to the multicast DRX configured in the cell for which the corresponding G-RNTI is configured. If multicast DRX is configured so as to correspond to each G-RNTI, values included in the corresponding multicast DRX configuration may include at least one of the DRX cycle length, the on-duration length (drx-onDurationTimerPTM), drx-InactivityTimerPTM, drx-HARQ-RTT-TimerDLPTM length, or drx-RetransmissionTimerDLPTM length. During multicast DRX configuration, the UE may have an on-duration of a predetermined time for each configured DRX cycle, and the on-duration may operate by means of drx-onDurationTimerPTM. When receiving a MAC PDU (or TB) by means of a G-RNTI or a connected G-CS-RNTI, the UE may start drx-InactivityTimerPTM. In some embodiments, drx-HARQ-RTT-TimerDLPTM may be started only if the UE has failed to successfully receive multicast data (that is, if failed to decode the corresponding TB). After expiration of drx-HARQ-RTT-TimerDLPTM, the UE may start drx-RetransmissionTimerDLPTM of multicast DRX regarding the G-RNTI corresponding to the drx-HARQ-RTT-TimerDLPTM (750). The drx-RetransmissionTimerDLPTM may be started only if corresponding multicast data is not successfully received (that is, if decoding of the corresponding TB has failed). During the multicast DRX operation, the UE may perform PDCCH monitoring by using the corresponding G-RNTI and G-CS-RNTI only in the active time interval, and may not perform PDCCH monitoring by using the corresponding G-RNTI and G-CS-RNTI outside of the active time interval, thereby reducing power consumption. In connection with multicast DRX, if at least one of the following conditions is satisfied, the same may be defined as the active time.
drx-onDurationTimerPTM is running
drx-InactivityTimerPTM is running
drx-RetransmissionTimerDLPTM is running

In the embodiment of FIG. 7, in a period of time for which drx-RetransmissionTimerDLPTM is running, the UE may perform PDCCH monitoring by using the G-RNTI (and G-CS-RNTI) in consideration of the fact that the cell for which the G-RNTI is configured in the active time (or by considering that the same is in the active time) (760). This is advantageous in that the gNB is enabled to perform retransmission when drx-RetransmissionTimerDLPTM is running, thereby reducing the HARQ retransmission delay time after performing the previous transmission 710, and enabling the UE in the RRC inactive mode to receive the retransmission. The virtual feedback time 720 described in the embodiment of FIG. 7 may be configured by using at least one of a symbol unit, a slot unit, a subframe unit, a millisecond unit, and a microsecond unit, or may be configured by using other time units.

Although it has been assumed in the embodiment of FIG. 7 that the UE in the RRC inactive mode, which does not transmit HARQ feedback, performs a multicast DRX operation, the embodiment of FIG. 7 may also be applied to an operation in which a UE in the RRC connected mode transmits drx-HARQ-RTT-TimerDLPTM regardless of HARQ feedback transmission.

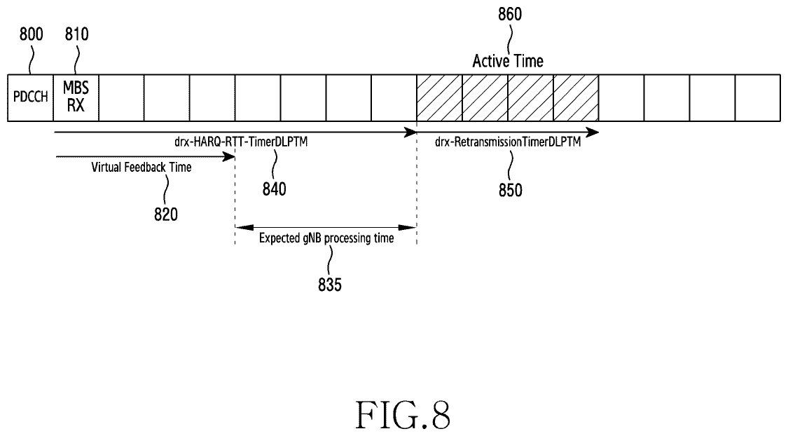

FIG. 8 illustrates a multicast DRX operation of a UE in an RRC inactive mode according to an embodiment of the disclosure.

After receiving multicast data (810), the UE in the RRC inactive mode cannot transmit HARQ feedback to the gNB to indicate whether the data has been successfully received or not. This is because the UE in the RRC inactive mode does not maintain uplink synchronization with the gNB and has no PUCCH resources configured therefor to transmit HARQ feedback. Therefore, with regard to the UE in the RRC inactive mode, it is unnecessary to configure the K1 value (for example, 220 in FIG. 2) to indicate the time taken to transmit HARQ feedback after receiving multicast data. On the other hand, if a UE in an RRC_connected mode has failed in multicast reception, the gNB may receive HARQ feedback from the UE in the RRC_connected mode and may perform HARQ retransmission, based thereon.

Meanwhile, according to an embodiment, the gNB may perform arbitrary retransmission even if no HARQ feedback is received (blind retransmission). In such a case, even in the case of a failure to receive multicast data (810), the UE in the RRC inactive mode may receive data retransmitted thereafter, thereby improving the quality of the multicast service. To this end, drx-HARQ-RTT-TimerDLPTM and drx-RetransmissionTimerDLPTM needs to be configured for the UE in the RRC inactive mode so as to define a procedure for facilitating multicast transmission/reception even in an environment having no HARQ feedback.

The embodiment in FIG. 8 corresponds to a method in which the UE in the RRC inactive mode starts a drx-HARQ-RTT-TimerDLPTM timer by using a separate drx-HARQ-RTT-TimerDLPTM value. The UE in the RRC inactive mode does not transmit HARQ feedback, but may determine the time length of the drx-HARQ-RTT-TimerDLPTM timer, including a virtual feedback time 820, in consideration of the HARQ feedback time of an RRC_connected UE (840). To the end, the length of the drx-HARQ-RTT-TimerDLPTM timer may be determined in consideration of both the virtual feedback time 820 and the expected gNB processing time 835 from HARQ feedback to retransmission resource assignment. In an example, the length of the drx-HARQ-RTT-TimerDLPTM timer may be configured to the sum of the virtual feedback time 820 and the expected gNB processing time 835 (840). The UE in the RRC inactive mode may start drx-HARQ-RTT-TimerDLPTM after configuring the drx-HARQ-RTT-TimerDLPTM value to be a value (for example, the sum) that considers both the virtual feedback time and the expected gNB processing time immediately before starting drx-HARQ-RTT-TimerDLPTM. The UE may apply and start the drx-HARQ-RTT-TimerDLPTM timer value from the next symbol immediately after the PDCCH resource 800 that indicates transmission of multicast data is ended (or from the next slot in which the PDCCH resource is ended) (840). In an embodiment, the expected gNB processing time may be configured to be included in the drx-HARQ-RTT-TimerDLPTM value itself through an RRC release message or MCCH message, and a separate timer (for example, drx-HARQ-RTT-TimerDLPTM-Inactive) may be configured as the sum of the drx-HARQ-RTT-TimerDLPTM value and the virtual feedback time.

According to an embodiment, the gNB may configure possible candidate groups regarding the virtual feedback time value for the UE through an RRC configuration (for example, RRC release message or MCCH), and may select one of values of the candidate groups and indicate the same to the UE through the PDSCH-to-HARQ_feedback Timing Indicator field of DCI of the PDCCH channel that indicates scheduling of a MAC PDU (or TB) of multicast data. The gNB may configure candidate groups of the virtual feedback time value through an RRC configuration (for example, RRC release message or MCCH) message, and may select the value of one of the candidate groups and indicate the same to the UE through DCI. The UE may select a virtual feedback time value, based thereon.

According to an embodiment, the virtual feedback time may be separately configured by using a symbol unit. For example, the entire the virtual feedback time may be configured to be the sum of a virtual feedback time indicated in the PDSCH-to-HARQ feedback Timing Indicator field and a symbol-unit virtual feedback time in a PUCCH resource indicator field. In connection with the symbol-unit virtual feedback time, candidate groups of the virtual feedback time value may be configured through an RRC configuration (for example, RRC release message or MCCH message), and the value of one of the candidate groups may be selected and indicated to the UE through DCI. The UE may select a symbol-unit virtual feedback time value, based thereon.

In an embodiment, the virtual feedback time 820 may be configured in an RRC release message or MCCH message transmitted to the UE by the gNB. Alternatively, the virtual feedback time may be configured by the gNB as one value for the UE in the PDSCH-to-HARQ_feedback Timing Indicator field of DCI.

In an embodiment, the symbol-unit virtual feedback time may be configured in an RRC release message or MCCH message transmitted to the UE by the gNB. Alternatively, the symbol-unit virtual feedback time may be configured by the gNB as one value for the UE in the PUCCH resource indicator field of DCI.

In the embodiment illustrated in FIG. 8, the virtual feedback time is configured to correspond to four slots (820), and the expected gNB processing time is configured to correspond to four slots (835). Therefore, the entire time length of drx-HARQ-RTT-TimerDLPTM may correspond to eight slots (840). Accordingly, the UE may run drx-HARQ-RTT-TimerDLPTM during an eight-slot length after the PDCCH resource 800 that indicates reception of multicast data is ended (840).

In order to reduce power consumed by a UE which receives multicast data, the gNB may configure multicast DRX for the UE. The multicast DRX may be configured with regard to each G-RNTI of the UE, and the UE may operate according to the multicast DRX configured in the cell for which the corresponding G-RNTI is configured. If multicast DRX is configured so as to correspond to each G-RNTI, values included in the corresponding multicast DRX configuration may include at least one of the DRX cycle length, the on-duration length (drx-onDurationTimerPTM), drx-InactivityTimerPTM, drx-HARQ-RTT-TimerDLPTM length, or drx-RetransmissionTimerDLPTM length. During multicast DRX configuration, the UE may have an on-duration of a predetermined time for each configured DRX cycle, and the on-duration may operate by means of drx-onDurationTimerPTM. When receiving a MAC PDU (or TB) by means of a G-RNTI or a connected G-CS-RNTI, the UE may start drx-InactivityTimerPTM. In some embodiments, drx-HARQ-RTT-TimerDLPTM may be started only if the UE has failed to successfully receive multicast data (that is, if failed to decode the corresponding TB). After expiration of drx-HARQ-RTT-TimerDLPTM, the UE may start drx-RetransmissionTimerDLPTM of multicast DRX regarding the G-RNTI corresponding to the drx-HARQ-RTT-TimerDLPTM (850). The drx-RetransmissionTimerDLPTM may be started only if corresponding multicast data is not successfully received (that is, if decoding of the corresponding TB has failed). During the multicast DRX operation, the UE may perform PDCCH monitoring by using the corresponding G-RNTI and G-CS-RNTI only in the active time interval, and may not perform PDCCH monitoring by using the corresponding G-RNTI and G-CS-RNTI outside of the active time interval, thereby reducing power consumption. In connection with multicast DRX, if at least one of the following conditions is satisfied, the same may be defined as the active time.
drx-onDurationTimerPTM is running
drx-InactivityTimerPTM is running
drx-RetransmissionTimerDLPTM is running

In the embodiment of FIG. 8, in a period of time for which drx-RetransmissionTimerDLPTM is running, the UE may perform PDCCH monitoring by using the G-RNTI (and G-CS-RNTI) in consideration of the fact that the cell for which the G-RNTI is configured in the active time (or by considering that the same is in the active time) (860). This is advantageous in that the gNB is enabled to perform retransmission when drx-RetransmissionTimerDLPTM is running, thereby reducing the HARQ retransmission delay time after performing the previous transmission 810, and enabling the UE in the RRC inactive mode to receive the retransmission. The virtual feedback time 820 described in the embodiment of FIG. 8 may be configured by using at least one of a symbol unit, a slot unit, a subframe unit, a millisecond unit, and a microsecond unit, or may be configured by using other time units.

Although it has been assumed in the embodiment of FIG. 8 that the UE in the RRC inactive mode, which does not transmit HARQ feedback, performs a multicast DRX operation, the embodiment of FIG. 8 may also be applied to an operation in which a UE in the RRC_connected mode transmits drx-HARQ-RTT-TimerDLPTM regardless of HARQ feedback transmission.

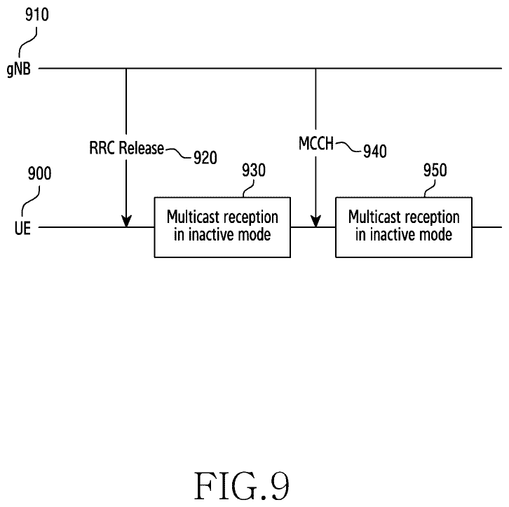

FIG. 9 illustrates a multicast DRX operation of a UE in an RRC inactive mode according to an embodiment of the disclosure.

If the gNB 910 determines that the UE 900 does not need to maintain an RRC_connected state, the gNB 910 may transmit an RRC release message to the UE 900, thereby instructing the UE 900 to transition to an RRC_idle mode or RRC inactive mode. In order for the UE 900 to continuously maintain multicast reception, an MBS radio bearer for multicast needs to be configured, and since the radio bearer is released in the RRC_idle mode, the UE needs to transition to an RRC inactive mode state. To this end, the gNB 910 may include Suspend Config information in the RRC release message, thereby instructing the UE 900 to transition to an RRC inactive mode (not RRC_idle mode) (920). Information of an MBS radio bearer for multicast, information of a multicast session, multicast DRX, and the like may be configured in the RRC release message, such that the UE 900 can receive multicast data in the RRC inactive mode. The starting timepoint of drx-HARQ-RTT-TimerDLPTM used by the UE 900 to receive multicast data in the RRC inactive mode, the starting slot thereof, the starting symbol, or the like may be determined, based thereon. The UE 900 may receive multicast data in the RRC inactive mode, based on a determination made according to received information (930).

Therefore, the gNB 910 may transmit an MCCH message including at least one piece of information among of information of an MBS radio bearer for multicast, information of a multicast session, or multicast DRX to the UE 900 in order to update multicast reception information regarding the UE 900 in the RRC inactive mode (940). The UE 900 may determine the starting timepoint of drx-HARQ-RTT-TimerDLPTM used to receive multicast data in the RRC inactive mode, the starting slot thereof, the starting symbol, or the like. The UE 900 may receive multicast data in the RRC inactive mode, based on a determination made according to received information (950).

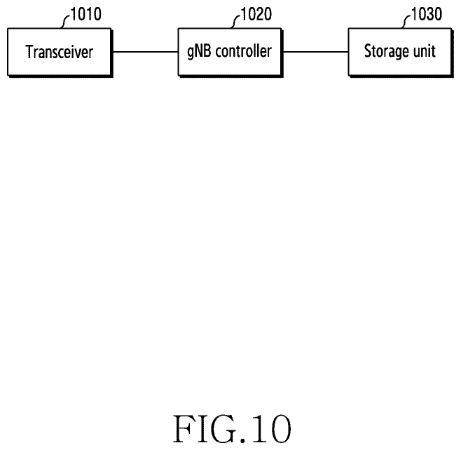

FIG. 10 illustrates a structure of a base station according to an embodiment of the disclosure.

Referring to FIG. 10, the base station may include a transceiver 1010, a base station controller 1020, and a storage 1030. As used herein, the base station controller 1020 may be defined as a circuit, an application specific integrated circuit, or at least one processor. The transceiver 1010 may transmit/receive signals with other network entities. For example, the transceiver 1010 may transmit system information to a UE, transmit synchronization signals, reference signals to the UE, and configuration information, and receive uplink signals from the UE. The base station controller 1020 may control the overall operation of the base station according to the embodiments proposed in the disclosure. For example, the base station controller 1020 may control signal flows between the respective blocks to perform operations according to the above-described flowcharts. The storage 1030 may store at least one of information transmitted/received through the transceiver 1010 and information generated through the base station controller 1020.

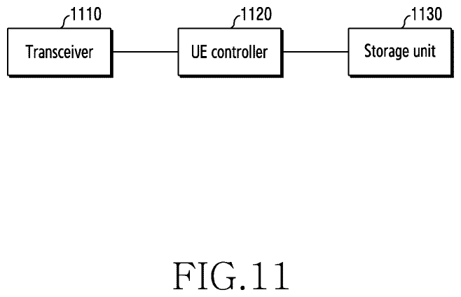

FIG. 11 illustrates a structure of a UE according to an embodiment of the disclosure.

Referring to FIG. 11, the UE may include a transceiver 1110, a UE controller 1120, and a storage 1130. As used herein, the UE controller 1120 may be defined as a circuit, an application specific integrated circuit, or at least one processor. The transceiver 1110 may transmit/receive signals with other network entities. For example, the transceiver 1110 may receive system information from a base station, receive synchronization signals, reference signals, and configuration information from the base station, and transmit uplink signals to the base station. The UE controller 1120 may control the overall operation of the UE according to the embodiments proposed in the disclosure. For example, the UE controller 1120 may control signal flows between the respective blocks to perform operations according to the above-described flowcharts. The storage 1130 may store at least one of information transmitted/received through the transceiver 1110 and information generated through the UE controller 1120.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. In addition, a plurality of such memories may be included in the electronic device.

Furthermore, the programs may be stored in an attachable storage device which can access the electronic device through communication networks such as the Internet, Intranet, Local Area Network (LAN), Wide LAN (WLAN), and Storage Area Network (SAN) or a combination thereof. Such a storage device may access the electronic device via an external port. Also, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Although specific embodiments have been described in the detailed description of the disclosure, it will be apparent that various modifications and changes may be made thereto without departing from the scope of the disclosure. Therefore, the scope of the disclosure should not be defined as being limited to the embodiments set forth herein, but should be defined by the appended claims and equivalents thereof.

Furthermore, the methods described above in FIGS. 1 to 9 may include methods in which one or more of the drawings are combined according to various implementations. For example, the embodiments described in FIG. 1 to FIG. 9 may be combined to be connected (performed) as one flow. In addition, all or a part of an embodiment may be performed in combination with all or a part of one or more other embodiments. The disclosure may include methods in which one or more of the drawings are combined according to various implementations.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a terminal in a wireless communication system, the method comprising:
receiving, from a base station, a radio resource control (RRC) release message including a suspend configuration, wherein the suspend configuration includes a multicast and broadcast service (MBS) multicast configuration for an RRC inactive state;
receiving, from the base station while the terminal is in the RRC inactive state, a multicast transmission based on the MBS multicast configuration; and
in case that a discontinuous reception hybrid automatic repeat request round trip time timer for downlink point to multipoint (drx-HARQ-RTT-TimerDL-PTM) is included in the MBS multicast configuration for the RRC inactive state, starting the drx-HARQ-RTT-TimerDL-PTM after an end of the multicast transmission.

2. The method of claim 1, wherein the drx-HARQ-RTT-TimerDL-PTM is started in a first symbol after the end of the multicast transmission.

3. The method of claim 1, wherein the drx-HARQ-RTT-TimerDL-PTM includes a number of symbols.

4. The method of claim 1, further comprising, in case that the drx-HARQ-RTT-TimerDL-PTM expires and a data of the multicast transmission is not successfully decoded, starting a discontinuous retransmission timer for downlink point to multipoint (drx-RetransmissionTimerDL-PTM).

5. The method of claim 4, further comprising receiving, from the base station while the terminal is in the RRC inactive state, a retransmission of the multicast transmission.

6. A method performed by a base station in a wireless communication system, the method comprising:
transmitting, to a terminal, a radio resource control (RRC) release message including a suspend configuration, wherein the suspend configuration includes a multicast and broadcast service (MBS) multicast configuration for an RRC inactive state; and
transmitting, to the terminal in the RRC inactive state, a multicast transmission based on the MBS multicast configuration,
wherein a discontinuous reception hybrid automatic repeat request round trip time timer for downlink point to multipoint (drx-HARQ-RTT-TimerDL-PTM) included in the MBS multicast configuration is started after an end of the multicast transmission.

7. The method of claim 6, wherein the drx-HARQ-RTT-TimerDL-PTM is started in a first symbol after the end of the multicast transmission.

8. The method of claim 6, wherein the drx-HARQ-RTT-TimerDL-PTM includes a number of symbols.

9. The method of claim 6, wherein a discontinuous retransmission timer for downlink point to multipoint (drx-RetransmissionTimerDL-PTM) is started based on an expiry of the drx-HARQ-RTT-TimerDL-PTM and a decoding failure of a data of the multicast transmission.

10. The method of claim 9, further comprising transmitting, to the terminal in the RRC inactive state, a retransmission of the multicast transmission.

11. A terminal in a wireless communication system, the terminal comprising:
a transceiver; and
a controller coupled with the transceiver and configured to:
receive, from a base station, a radio resource control (RRC) release message including a suspend configuration, wherein the suspend configuration includes a multicast and broadcast service (MBS) multicast configuration for an RRC inactive state,
receive, from the base station while the terminal is in the RRC inactive state, a multicast transmission based on the MBS multicast configuration, and
in case that a discontinuous reception hybrid automatic repeat request round trip time timer for downlink point to multipoint (drx-HARQ-RTT-TimerDL-PTM) is included in the MBS multicast configuration for the RRC inactive state, start the drx-HARQ-RTT-TimerDL-PTM after an end of the multicast transmission.

12. The terminal of claim 11, wherein the drx-HARQ-RTT-TimerDL-PTM is started in a first symbol after the end of the multicast transmission.

13. The terminal of claim 11, wherein the drx-HARQ-RTT-TimerDL-PTM includes a number of symbols.

14. The terminal of claim 11, wherein the controller is further configured to, in case that the drx-HARQ-RTT-TimerDL-PTM expires and a data of the multicast transmission is not successfully decoded, start a discontinuous retransmission timer for downlink point to multipoint (drx-RetransmissionTimerDL-PTM).

15. The terminal of claim 14, wherein the controller is further configured to receive, from the base station while the terminal is in the RRC inactive state, a retransmission of the multicast transmission.

16. A base station in a wireless communication system, the base station comprising:
a transceiver; and
a controller coupled with the transceiver and configured to:
transmit, to a terminal, a radio resource control (RRC) release message including a suspend configuration, wherein the suspend configuration includes a multicast and broadcast service (MBS) multicast configuration for an RRC inactive state, and
transmit, to the terminal in the RRC inactive state, a multicast transmission based on the MBS multicast configuration,
wherein a discontinuous reception hybrid automatic repeat request round trip time timer for downlink point to multipoint (drx-HARQ-RTT-TimerDL-PTM) included in the MBS multicast configuration is started after an end of the multicast transmission.

17. The base station of claim 16, wherein the drx-HARQ-RTT-TimerDL-PTM is started in a first symbol after the end of the multicast transmission.

18. The base station of claim 16, wherein the drx-HARQ-RTT-TimerDL-PTM includes a number of symbols.

19. The base station of claim 16, wherein a discontinuous retransmission timer for downlink point to multipoint (drx-RetransmissionTimerDL-PTM) is started based on an expiry of the drx-HARQ-RTT-TimerDL-PTM and a decoding failure of a data of the multicast transmission.

20. The base station of claim 19, wherein the controller is further configured to transmit, to the terminal in the RRC inactive state, a retransmission of the multicast transmission.
